(19) United States
(12) Patent Application Publication
(10) Pub. No.: US 2002/0081144 A1
(43) Pub. Date: Jun. 27, 2002

(54) Sheet having a universal retention member for a binder system

(76) Inventor: Michael Lamming, St. Louis, MO (US)

Correspondence Address: Lewis, Rice and Fingersh, L.C., Suite 2000, 500 N. Broadway, St. Louis, MO, 63102-2147, US

(21) Appl. No.: 09/981,630

(22) Filed: Oct. 17, 2001

Related U.S. Application Data
(63) Continuation of application No. 09/390,608, filed on Sep. 3, 1999, now abandoned.

(51) Int. Cl. B42F 13/00

(52) U.S. Cl. 402/79

(57) ABSTRACT

A sheet for a binder system having a universal retention member is provided. The universal retention member includes at least one aperture defining a slot portion with a hole portion at one end. The slot portion includes an opening at the other end of the slot portion. The binder system also includes a binder having a securement mechanism adapted to secure the sheet to the binder such as a post, ring, strap which is receivable within the aperture. The opening is sized to reduce frictional wear and snagging between the aperture and securement mechanism while also enhancing the structural integrity of the region surrounding the aperture.

### BACKGROUND OF THE INVENTION

1. Field of the Invention

The present invention relates to binder systems, and more particularly to a sheet having a universal retention member forming an aperture adapted to receive a post, ring, strap or other similar securement mechanism. More specifically, the present invention relates to an aperture adapted to reduce frictional wear and snagging between the securement mechanism and the aperture.

2. Prior Art

Binder systems are well known in art to usually include a plurality of sheets attached within a binder by a securement device. Generally, three types of securement mechanisms have been utilized in the art: a post/hole mechanism, a ring/hole mechanism and a strap/slot mechanism.

Post/hole mechanisms generally include posts affixed to a binder which are sized to be received within holes punched through or otherwise formed in sheets to be retained by the binder. Once the sheets are fitted on the post, they may be secured in place. One such device typical of this type of binder system is U.S. Pat. No. 5,127,755 to Bee entitled “Binder With Security Lock Feature.” This reference discloses a binder having a front cover and a back cover connected along a spine with a post assembly which is defined by three posts that extend transverse to the spine. Each of these posts includes a pair of interchangeable post elements that are separable to permit the sheets to be inserted and removed from the binder.

Another device well known in the art is the ring/hole mechanism, which includes a plurality of rings attached along the spine of a binder. One such device typical of these devices is disclosed in U.S. Pat. No. 3,936,201 to Kennedy et al. entitled “Hanger and Sheet Lifter for Ring Binder” which discloses a binder having a front cover joined to a back cover along a spine with three rings attached thereto. Each of the rings is biased between an open position whereby the sheets may be removed from the rings and a closed position wherein the sheets are securely retained by the rings. The rings may be biased between the open position and the closed position by a release mechanism which may be digitally actuated by a user.

Yet another common securement mechanism is a strap/slot mechanism as disclosed in U.S. Pat. No. 2,250,755 to Farkas et al. entitled “Book and Binding for Same.” This reference discloses a plurality of tongues, or straps, that extend from the cover. The straps are threaded through a slot formed in the sheet and then secured to the cover by an adhesive.

Although the above-mentioned securement devices function adequately to secure sheets to a binder, additional advances would still be desirable in the art. Manufacturers who sell binder systems utilizing the above mentioned securement devices would typically provide sheets adapted for use only with their own system. However, doing so had drawbacks. For instance, sheets which have been configured for use with only one of the above-described securement mechanisms are not interchangeable. Retailers which sell binder systems of more than one manufacturer are forced to stock a multitude of sheets specifically adapted for each different securement mechanism. Another disadvantage to the above-described binder systems is that customers are prone to purchasing the wrong sheet because they would have to search for a particular sheet adapted for use in their particular binder system among the multitude of sheets sold by the retailer.

In an attempt to advance the art, sheets having universal retention members have been adapted for use with securement mechanisms from various manufacturers. One such sheet 110, as shown in FIG. 1, is currently manufactured by Pioneer Photo Albums, Inc. of Chatsworth, Calif., under Model Nos. RW-85, RB-85. This sheet 110 includes a universal retention member that has a pair of apertures 148 and a center hole 150. As further shown in FIG. 1, each of the apertures 148 includes a slot portion 152 and a hole portion 154 formed at one end with a radiused portion 158 formed at the other end of the slot portion 152. This configuration of the aperture 148 allows the sheet 110 to be utilized with binders having a variety of different securement mechanisms. For instance, when utilized with a strap/hole securement mechanism shown in FIG. 4, each strap 32 is fitted through a corresponding aperture 148 with strap 32 positioned within the slot portion 152. The sheet 110 may also be utilized with a ring/hole securement mechanism illustrated in FIG. 3, whereby each ring is fitted through the corresponding aperture 148 with the ring positioned within the hole 154. Referring to FIG. 2, the same sheet 110 may also be utilized with a post/hole securement mechanism by fitting each post through the corresponding aperture 148 with the post positioned within hole 154. Although sheets 110 having a universal retention mechanism may have advanced the art, several advancements would still be desirable. For instance, it has been found that devices manufactured in accordance with the teachings of Pioneer are prone to excessive wear along the radiused portion 158, thereby leading to failure of the aperture 148 due to fraying or binding. Another drawback found with these devices is that the minimal clearance between the slot portion 152 and the strap often leads to jamming or snagging of the sheets 110 as the pages are pivoted whenever a user flips the sheets 110 retained in the binder.

Therefore, it would be desirable to have a sheet with a universal retention member that reduces the opportunity for frictional wear. It would also be desirable to have a universal member that prevents the sheet from undesirably snagging or catching on the securement mechanism during operation. Further, it would also be desirable to have a universal retention member which enhances the structural integrity of the region surrounding the aperture.

### OBJECTS AND SUMMARY OF THE INVENTION

In brief summary, the present invention overcomes and substantially alleviates the deficiencies in the prior art by providing a sheet for a binder system having a universal retention member.

The sheet of the present invention may be utilized with binders having a variety of different securement mechanisms. For instance, the sheet may be utilized with a binder system having a post/hole securement mechanism, a ring/hole securement mechanism, or a strap/slot securement mechanism. Binder systems having a post/hole securement mechanism typically include a binder having a front cover with a flap, a rear cover with a flap, a spine attached therebetween and a plurality of posts attached between the flaps. Each of the posts include a first member and a second member which may be releasably interconnected. The sheet may also be utilized with binder systems having a ring/hole securement mechanism. These binder systems typically include a binder having a front cover attached to a rear cover along a spine with a plurality of rings attached thereto. Each of the rings are bifurcated so that they may be biased between open and closed positions. In order to actuate the rings between the open and closed positions, a release mechanism is disposed along the spine in communication with the rings. The sheet may also be utilized with binder systems that include a front cover attached to a rear cover along a spine with a strap attached thereto which extends outwardly from the opening.

The sheet of the present invention includes a body which is generally rectangular and defined by an inner edge, an outer edge, a top edge, and a bottom edge. The sheet further includes a universal retention member preferably having a pair of apertures and a center hole disposed along the inner edge of the sheet.

One unique aspect of the present invention is the configuration of the aperture which comprises a slot portion and a hole portion. Further, the slot portion includes an opening at the end of slot portion. The hole portion is sized to receive a post or a ring therethrough, while the slot portion is sized to received a strap therethrough. In order to reduce the opportunity for frictional wear between the strap and the aperture, the opening is sized large enough to distribute frictional forces along the edge of the opening. In addition, the configuration of the opening reduces the possibility that the sheet will snag on the strap when the sheet is turned. Failure of the aperture is also reduced since the opening is sized to enhance the structural integrity of the region surrounding the aperture. Accordingly, the primary object of the present invention is to provide a sheet having a universal retention member which reduces frictional wear between the aperture and securement mechanism.

Another object of the present invention is to provide a universal retention member which prevents the sheet from snagging or otherwise catching on the securement mechanism.

Yet another object of the present invention is to have a universal retention member that enhances the structural integrity of the region surrounding the aperture.

A further object of the present invention is to provide a universal retention member that is adapted for use with various securement mechanisms.

Another further object of the present invention is to provide a universal retention member which distributes frictional forces over a greater surface area.

These and other objects of the present invention are realized in the preferred embodiment of the present invention, described by way of example and not by way of limitation, which provides for a binder system having a sheet with an aperture defining a slot having a hole at one end and an opening disposed at the other end which is adapted to reduce frictional wear and prevent snagging between the securement mechanism and the aperture.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1. is a top plan view of a prior art retention mechanism;

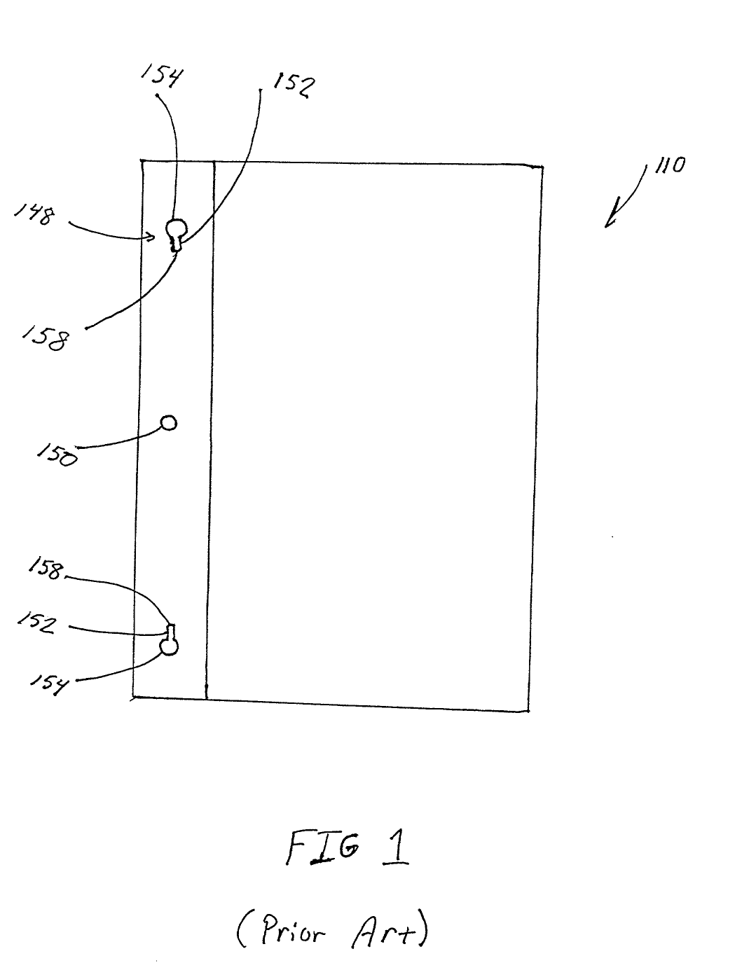

FIG. 2. is a perspective view of a prior art binder having a post/hole securement mechanism.

FIG. 3. is a perspective view of a prior art binder having a ring/hole securement mechanism.

FIG. 4. is a perspective view of a prior art binder having a strap/aperture securement mechanism.

FIG. 5. is a perspective view of a sheet having a universal retention member according to the present invention;

FIG. 6. is a top plan view of the sheet having the universal retention member according to the present invention;

FIG. 7. is a fragmentary top plan view of the sheet showing an aperture of the universal retention member according to the present invention;

FIG. 8 is a fragmentary top plan view of the sheet showing an aperture with a ring disposed therethrough according to the present invention; and

FIG. 9 is a fragmentary top plan view of the sheet showing an aperture with a strap disposed therethrough according to the present invention.

### DETAILED DESCRIPTION OF THE INVENTION

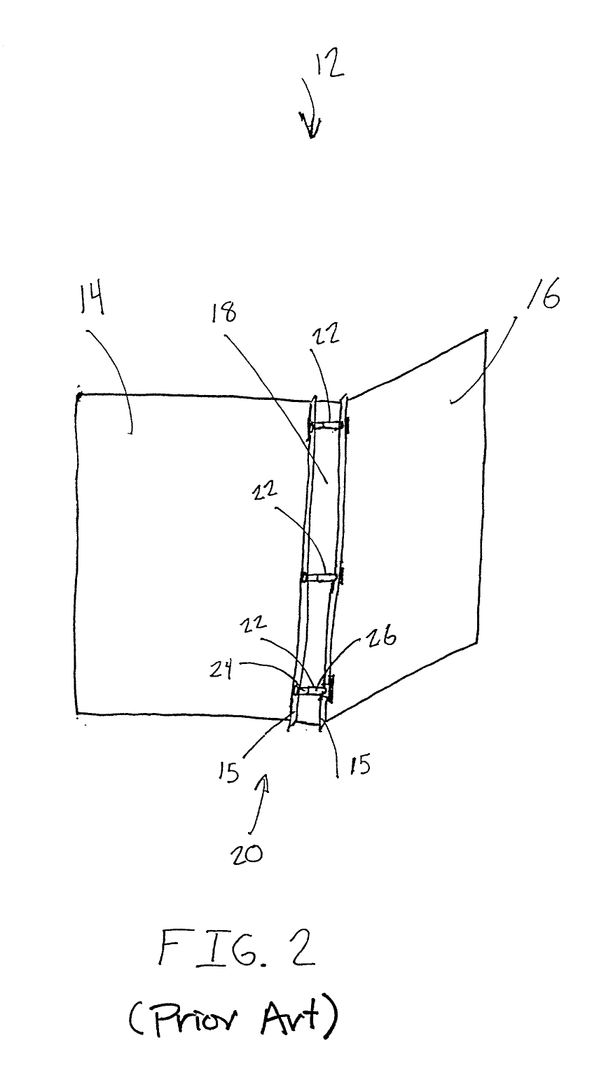

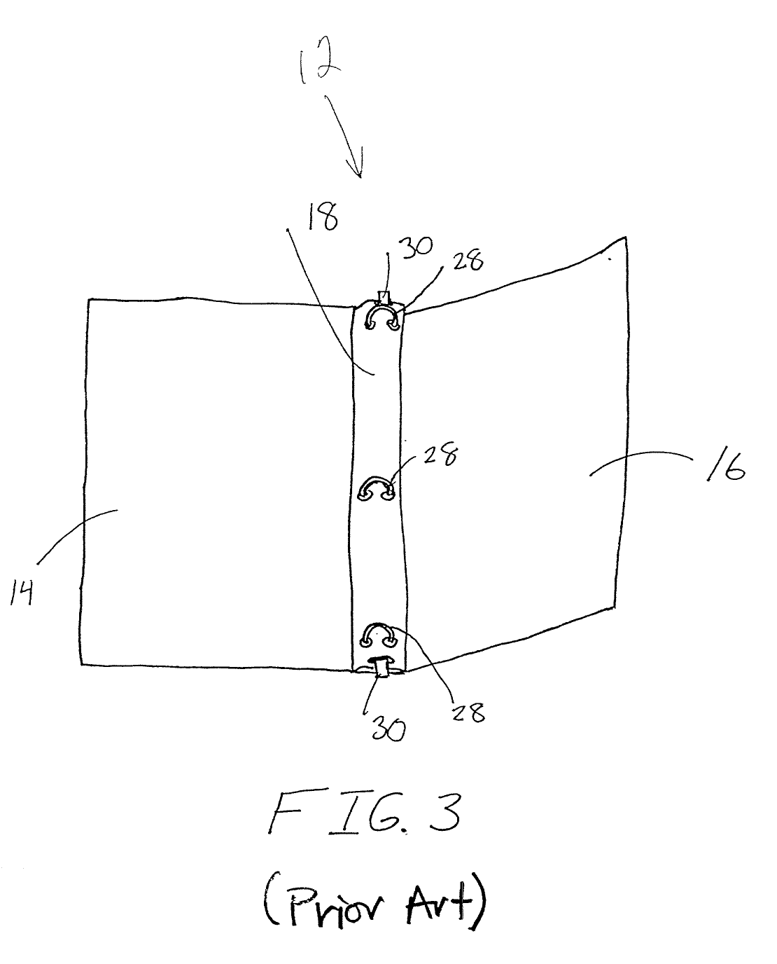

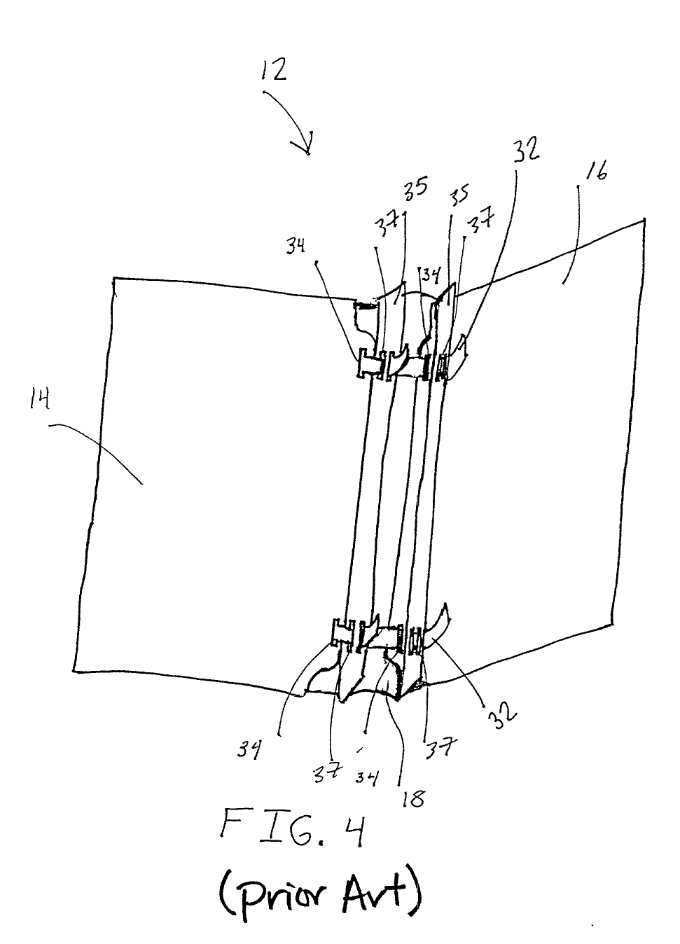

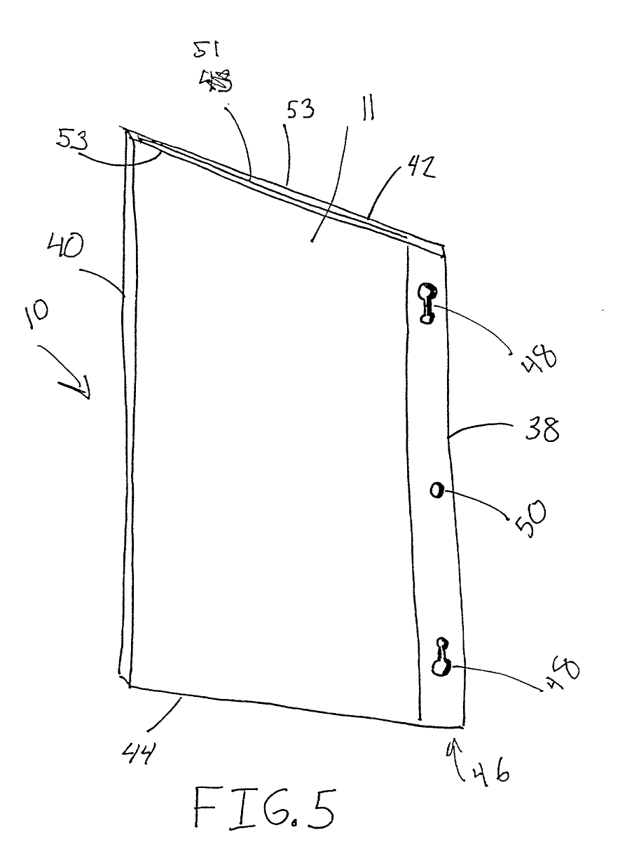

Referring to the drawings, the preferred embodiment of the sheet having a universal retention member of the present invention is illustrated and generally indicated as 10 in FIG. 5. Sheet 10 of the present invention may be utilized with a binder 12 having a variety of different securement mechanisms 20 such as a post/hole securement mechanism (FIG. 2), a ring/post securement mechanism (FIG. 3), or a strap/slot securement mechanism (FIG. 4).

With particular reference to FIG. 2, sheet 10 of the present invention may be utilized with binder 12 for retaining one or more sheets 10 therein. Binder 12 includes front cover 14, rear cover 16, and spine 18 attached therebetween with a pair of flaps 15 connected to spine 18. Sheet 10 is secured to binder 12 by securement mechanism 20 which includes a plurality of posts 22. Each of the posts 22 includes a first member 24 and a second member 26 which may be releasably interconnected to retain sheet 10.

With reference to FIG. 3, sheet 10 of the present invention may also be utilized with binder 12 having a front cover 14 attached to rear cover 16 along spine 18. Sheet 10 is secured to binder 12 by securement mechanism 20 which includes a plurality of rings 28. Each of the rings 28 are bifurcated so that they may be biased between open (whereby the sheets are removable) and closed positions (whereby the sheets are securely held in place). In order to actuate the rings 28 between the open and closed positions, a release mechanism 30 is provided which is disposed along spine 18 in communication with rings 28.

As seen in FIG. 4, sheet 10 of the present invention may be utilized with binder 12 having front cover 14 attached to rear cover 16 along spine 18 and a pair of straps 32 connected therebetween for securing sheet 10 to binder 12. Front cover 14 and rear cover 16 each include a pair of openings 34. The binder 12 also includes a pair of flaps 35, each defining a pair of double slits 37. Each strap 32 is fitted through opening 34 in front cover 14, threaded through the double slits 37 in flaps 35, 17 and then fitted through opening 34 in rear cover 16.

With particular reference to FIG. 5, sheet 10 of the present invention includes body 11 which is generally rectangular and defined by an inner edge 38, outer edge 40, top edge 42, and bottom edge 44. Preferably, the height of sheet 10 between top edge 42 and bottom edge 44 is approximately 9.250 inches, while the width of sheet 10 between inner edge 38 and outer edge 40 is approximately 11.188 inches. However, sheet 10 may also have alternate dimensions tailored to accommodate various sized binders. Sheet 10 further includes a universal retention member 46 having a pair of apertures 48 and a center hole 50 disposed along inner edge 38 of sheet 10.

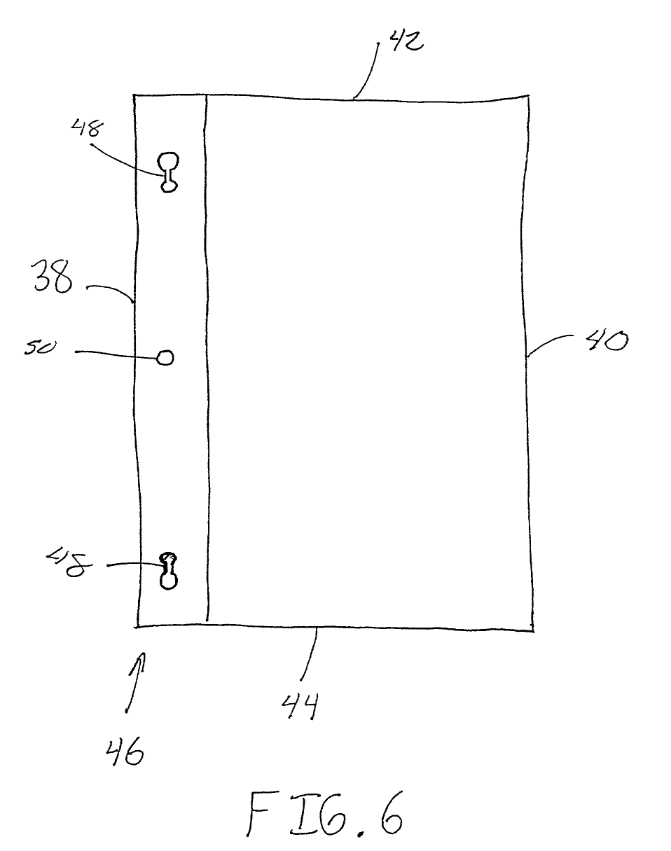

The present invention is configured to retain objects such as photographs or other items. To receive these objects therein, sheet 10 includes a pocket 51 defined by a pair of layers 53. Preferably, pocket 51 is approximately 8½×11 inches; however one skilled in the art can best appreciate that a variety of different sized and shaped pockets may be utilized without departing from the spirit of this invention. In the preferred embodiment shown in FIG. 6, the center hole 50 is disposed at the approximate midpoint between top edge 42 and bottom edge 44 while apertures 48 are spaced from top edge 42 and bottom edge 44, respectively, by a distance of approximately 1.375 inches. Both apertures 48 and center hole 50 are approximately 0.344 inches from inner edge 38. However, center hole 50 and apertures 48 may be spaced at any suitable distance from one another and fall within the scope of the present invention.

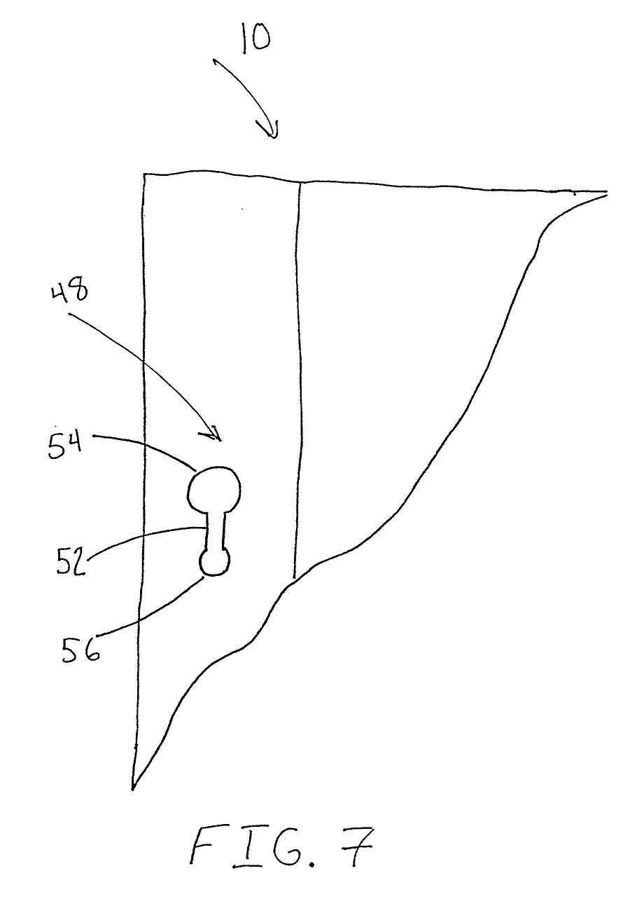

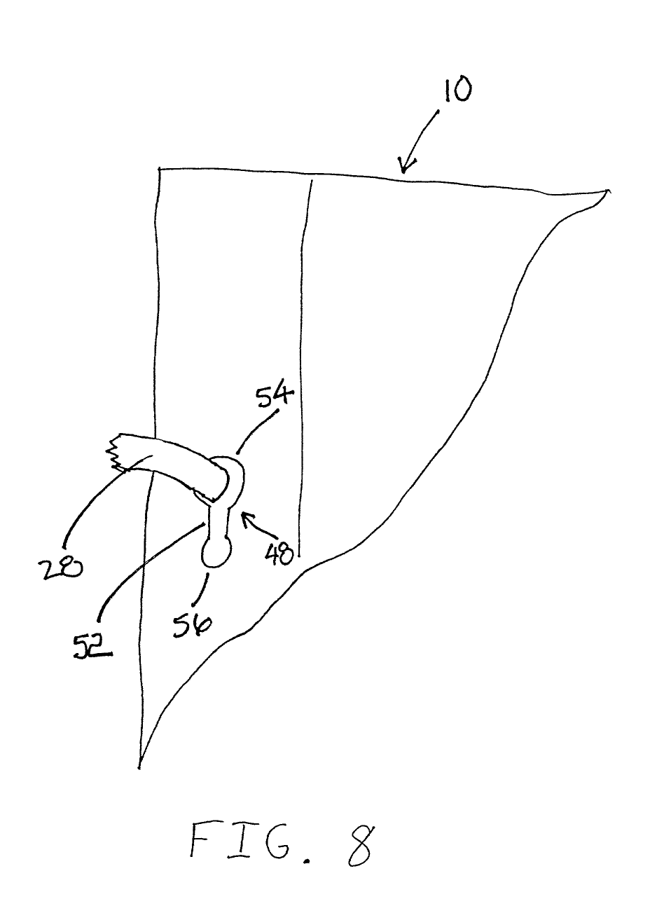

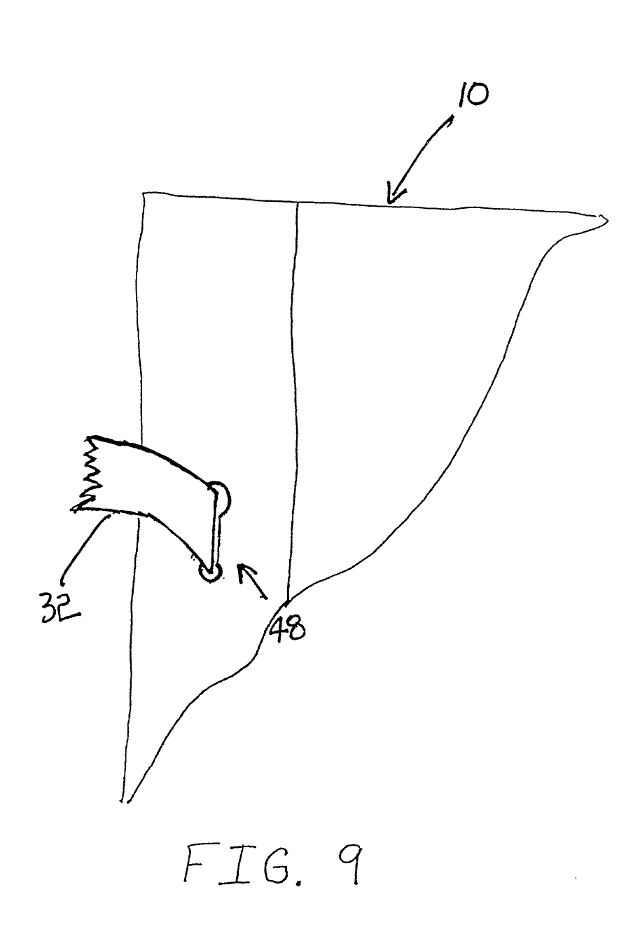

As best appreciated with referenced to FIG. 7., one unique aspect of the present invention is the configuration of aperture 48. Specifically, aperture 48 includes slot portion 52 and a hole portion 54 at one end of slot portion 52. Slot portion 52 also comprises an opening 56 at an end opposite hole portion 54. Hole portion 54 is sized to receive post 22 or ring 28 therethrough (FIG. 8), while slot portion 52 is sized to receive strap 32 therethrough (FIG. 9). Another unique aspect of the present invention is that opening 56 is configured to reduce the opportunity for frictional wear when strap 32 is utilized with sheet 10 of the present invention since opening 56 provides additional clearance between aperture 48 and strap 32. In addition, the possibility that sheet 10 snags or catches on strap 32 is also minimized due to the increased clearance provided by opening 56. The reduction of frictional wear about aperture 48 is achieved by sizing opening 56 to a radius greater than the width of slot 52, yet less than the diameter of the hole portion 54. It has been found that openings with large diameters distribute stresses more efficiently than a radiused slot of the prior art. However, openings with diameters that are larger than the diameter of hole portion 54 have been found to exhibit decreased structural integrity, since the additional material reduction in the margin surrounding the aperture begins to reduce the overall structural integrity. Preferably, the diameter of hole portion 54 is 0.250 inches and the diameter of opening 56 is 0.100 inches while the width of slot portion 52 is 0.065 inches, although other suitable dimensions may be used.

In use, the present invention may be utilized to secure a sheet 10 to a binder having a variety of different securement mechanisms 20, such as the post/hole securement mechanism (FIG. 2), wherein each of the posts 22 are fitted through a corresponding hole portion 54 and center hole 50. Alternatively, the present invention may also be utilized with a binder 12 having a ring/hole securement mechanism (FIG. 3) by inserting a corresponding ring 28 also through hole portion 54 and center hole 50 of sheet 10. Finally, the present invention may also be utilized with a binder 12 having a securement mechanism 20 including straps 32 by passing the straps 32 through slot portion 52.

As the sheet 10 is utilized in binder 12, the user may pivot the sheet 10 relative to binder 12 without sheet 10 being frictionally worn due to the interaction between the strap 32 and the slot portion 52 of aperture 48, since opening 56 of portion 52 is sized to allow sheet 10 to be pivoted while also reducing the contact between aperture 48 and strap 32. Another novel aspect of the present invention is that opening 56 also achieves the above-noted friction reduction while not compromising the structural integrity of the region surrounding aperture 48. This increased structural integrity is achieved since the opening 56 is configured large enough to distribute frictional wear about aperture 48, while also reducing the possibility that sheet 10 will snag or otherwise catch strap 36. Finally, opening 56 is small enough to enhance the structural integrity of this region.

It should be understood from the foregoing that, while particular embodiments of the invention have been illustrated and described, various modifications can be made thereto without departing from the spirit and scope of the present invention. Therefore, it is not intended that the invention be limited by the specifications; instead, the scope of the present invention is intended to be limited only by the appended claims.

I/We Claim:

1. A sheet for a binder system comprising:
a body; and
a universal retention member including at least one aperture formed through said body, said aperture including a slot portion having a width with a hole portion formed at one end of the aperture, said slot portion having an opening formed at the other end of the aperture, each of said hole portions and said opening having a diameter.

2. The sheet according to claim 1, wherein the diameter of said opening is less than the diameter of said hole portion.

3. The sheet according to claim 1, wherein the diameter of said opening is greater than the width of said slot portion.

4. The sheet according to claim 1, wherein the diameter of said opening is greater than the width of said slot portion and less than the diameter of said hole portion.

5. The sheet according to claim 1, wherein said body defines a top edge and a bottom edge oppositely disposed relative to the top edge, said top edge and said bottom edge define a height therebetween, said body further defines an inner edge and an outer edge oppositely disposed relative to the inner edge, said inner edge and said outer edge define a width therebetween.

6. The sheet according to claim 5, wherein said width of said body is approximately about 9.250 inches and wherein said height of said body is approximately about 11.188 inches.

7. The sheet according to claim 1, wherein said body is formed from a substantially transparent material.

8. The sheet according to claim 1, wherein said body is formed from a polypropylene material.

9. The sheet according to claim 1, wherein said body is formed from at least two layers.

10. The sheet according to claim 9, wherein said layers are sealingly engaged along said inner edge, said outer edge and said bottom edge whereby a pocket is defined between said layers.

11. The sheet according to claim 1, wherein said diameter of said hole is approximately about 0.250 inches.

12. The sheet according to claim 1, wherein said diameter of said opening is approximately about 0.100 inches.

13. The sheet according to claim 1, wherein said width of said slot is approximately about 0.065 inches.

14. A binder system comprising:
a sheet including a body, said sheet further including a universal retention member including at least one aperture formed through said body, said aperture including a slot portion having a width with a hole portion formed at one end of the aperture, said slot portion having an opening formed at the other end of the aperture, each the hole portion and the aperture have a diameter; and
a binder having a securement mechanism adapted to receive the retention member.

15. The binder system according to claim 14, wherein the diameter of said opening is less than the diameter of said hole portion.

16. The binder system according to claim 14, wherein the diameter of said opening is greater than the width of said slot portion.

17. The binder system according to claim 14, wherein the diameter of said opening is greater than the width of said slot portion and the diameter of said opening is less than the diameter of the hole portion.

18. The binder system according to claim 14, wherein said body defines a top edge and a bottom edge oppositely disposed relative to the top edge, said top edge and said bottom edge define a height therebetween, said body further defines an inner edge and an outer edge oppositely disposed relative to the inner edge, said inner edge and said outer edge define a width therebetween.

19. The binder system according to claim 18, wherein said width of said body is approximately about 9.250 inches and wherein said height of said body is approximately about 11.188 inches.

20. The binder system according to claim 14, wherein said body is formed from a substantially transparent material.

21. The binder system according to claim 14, wherein said body is formed from a polypropylene material.

22. The binder system according to claim 14, wherein said body is formed from at least two layers.

23. The binder system according to claim 22, wherein said layers are sealingly engaged along said inner edge, said outer edge and said bottom edge whereby a pocket is defined between said layers.

24. The binder system according to claim 14, wherein said diameter of said hole is approximately about 0.250 inches.

25. The binder system according to claim 14, wherein said diameter of said opening is approximately about 0.100 inches.

26. The binder system according to claim 14, wherein said width of said slot portion is approximately about 0.065 inches.

27. The binder system according to claim 14, wherein said securement mechanism includes a strap attached to said binder, said strap being sized to be receivable through said aperture.
